(19) United States
(12) Patent Application Publication
(10) Pub. No.: US 2008/0109541 A1
(43) Pub. Date: May 8, 2008

(54) Method for automatic dispatching IP addresses to each testing apparatus in a testing system and the system

(75) Inventor: Warren Hsu, Taoyuan Hsien (TW)

Correspondence Address: BACON & THOMAS, PLLC, 625 SLATERS LANE, FOURTH FLOOR, ALEXANDRIA, VA, 22314, US

(73) Assignee: CHROMA ATE INC., Taoyuan Hsien (TW)

(21) Appl. No.: 11/798,667

(22) Filed: May 16, 2007

(30) Foreign Application Priority Data
Nov. 3, 2006 (TW) 095140848

(51) Int. Cl. G06F 15/177

(52) U.S. Cl. 709/222

(57) ABSTRACT

A method for automatic dispatching IP addresses to each testing apparatus in a testing system, according to this method, the testing system can automatically dispatch IP addresses to the each respective apparatus. The each testing apparatus comprises a testing circuit board for positioning a circuit element/device under test thereon; a network interface device, which is installed on the testing circuit board and stores an internal code; and a memory device connected to the testing circuit board, respectively. Thus the testing system can control each testing apparatus, so as to avoid labor consumption caused by repetitive dispatch of the IP addresses, as well as the loss due to shutdown of the product lines. Therefore, this method can solve the above-mentioned problems simultaneously.

### FIELD OF THE INVENTION

The present invention relates to a method for dispatching IP addresses, and in particular to a method for automatic dispatching IP addresses to each testing apparatus in a testing system.

### BACKGROUND OF THE INVENTION

Integrated circuits have, without doubt, become the core of electronics nowadays. Consequently the reliability of an integrated circuit has a great impact on the reliability of the product it is utilized in.

Currently IC testers could be categorized into 2 different types. One type of IC testers tests the electrical properties of the IC, while another type of IC testers tests the IC under actual usage. Although the former method could thoroughly test the electrical properties of the IC, it also requires extensive hardware and software setup. Not only does this setup require a lot of resources, it also requires a lot of time to reconfigure when an IC has its design updated. Thus not only is this method costly, it is also hard to keep up with the rapidly changing electronic world.

The testing method that tests the IC under actual usage, on the other hand, does not seek to obtain the electrical properties of the tested IC, but rather tests if the IC would actually work for its given application. Although this testing method takes a longer time, it easily determines the performance of the tested IC under actual usage and whether the IC is ready to be installed. Also, it is relatively easy to create the IC testing apparatus, for its main component need only be a product that has the IC being tested removed. These products are readily available in the market. For example, if the tested IC is a CPU, then the testing apparatus would mainly consist of a motherboard which has its CPU removed.

As shown in FIGS. 1 and 2, the testing method described above would include a central control module 90 which controls six testing apparatuses 92. Each testing apparatus includes a testing circuit board 920, a hard drive 922, a computer network interface 924, and a connector 926 connected to the testing circuit board. The testing procedure is stored in each hard drive 922. Signals are sent back and forth between the central control module 90 and the testing circuit board 920 of each testing apparatus 92 via the computer network interface 924, thus allowing the central control module 90 to control each testing apparatus 92 and each testing apparatus 92 to send test results to the central control module 90. The central control module 90 then uses the test results to determine whether the tested IC meets the standards required.

Yet there are some flaws in this testing method. Whenever a change in the type of IC tested occurs, the network of the system must be reconfigured from the central control module 90 and the content of the hard drives 922 of the testing apparatuses 92 must be updated. Hence this testing method requires a lot of manual effort and lacks efficiency.

Also, the hard drives 922 of each testing apparatus 92 must be turned off in order to replace an IC that has finished testing with a non-tested IC and turned on again to test the IC. Thus the hard drives are constantly turned on and off as the testing system tests one IC after another, which makes the hard drives very susceptible to failure due to cyclic loading. Whenever this happens, the hard drive 922 must be replaced by another which has the testing information installed onto it. If the wrong testing information is accidentally installed onto the hard drive, the testing procedure of the IC would be faulty. At its least, this error may lead to the rejection of a perfectly capable IC. At its worse, this error may lead to the acceptance of an incapable IC, which may lead to a faulty product line.

Also, there may be many product lines present in a single factory, thus it is highly possible that a testing system would need to test many different ICs. Whenever a change in the type of IC tested occurs, the information in the testing apparatuses must be updated, which makes the testing system vulnerable to the error described in the previous paragraph. In addition, a single worker must often man more than one testing system, which increases the probability of the error occurring.

If the configurations prior to the testing processes could be made automatic, then the chance of human error would be greatly reduced. If so then not only would the costs, efficiency and accuracy of interconnect tests be improved, the testing system itself would be a product of great potential.

### SUMMARY OF THE INVENTION

An objective of the present invention is to provide a method for automatic dispatching IP addresses to each testing apparatus in a testing system with reduced costs.

Another objective of the present invention is to provide a method for automatic dispatching IP addresses to each testing apparatus in a testing system with a reduced possibility of human error.

Another objective of the present invention is to provide a method for automatic dispatching IP addresses to each testing apparatus in a testing system with improved accuracy and efficiency of the test.

Another objective of the present invention is to provide a testing system capable of automatic dispatching IP addresses to each testing apparatus in a testing system.

Therefore, the method for automatic dispatching IP addresses to each testing apparatus in a testing system of the present invention, allowing to recognize a plurality of testing apparatuses for sensing the electrical properties of a plurality of the homotypic circuit elements/devices under test in a predetermined circuit environment, wherein the each testing apparatus comprises a testing circuit board for positioning a circuit element/device under test thereon; a network interface device, which is installed on the testing circuit board and stores an internal code; and a memory device connected to the testing circuit board, respectively; said method comprises the steps of: individually enabling one of said testing apparatuses, activating the testing circuit board, memory device and network interface device of said testing apparatus; receiving the request from said network interface device, reading the internal code thereof; memorizing said internal code, dispatching an IP address to be stored in said memory device of said testing apparatus; and disabling said testing apparatus dispatched with the IP address, enabling another one of said testing apparatuses without dispatch of an IP address, wherein all the dispatched IP addresses are nonrepeatable, continuing the above-mentioned steps until said testing apparatuses are all dispatched with IP addresses and thereby said system could recognize said each testing apparatus clearly.

By using said testing system to control each testing apparatus and to dispatch each different IP address to each testing apparatus, the role which human error may play in the testing process would be greatly reduced, then the efficiency and accuracy of the test would be improved.

### BRIEF DESCRIPTION OF THE DRAWINGS

The above-mentioned and other technical contents, features, and functions of the present invention are clearly illustrated in the following detailed description of the preferred embodiments in coordination with the reference drawings.

FIG. 1 is a pictorial schematic diagram of a conventional automatic IC testing system under room temperature, illustrating the relationship between the IC supply/output devices and the testing apparatuses;

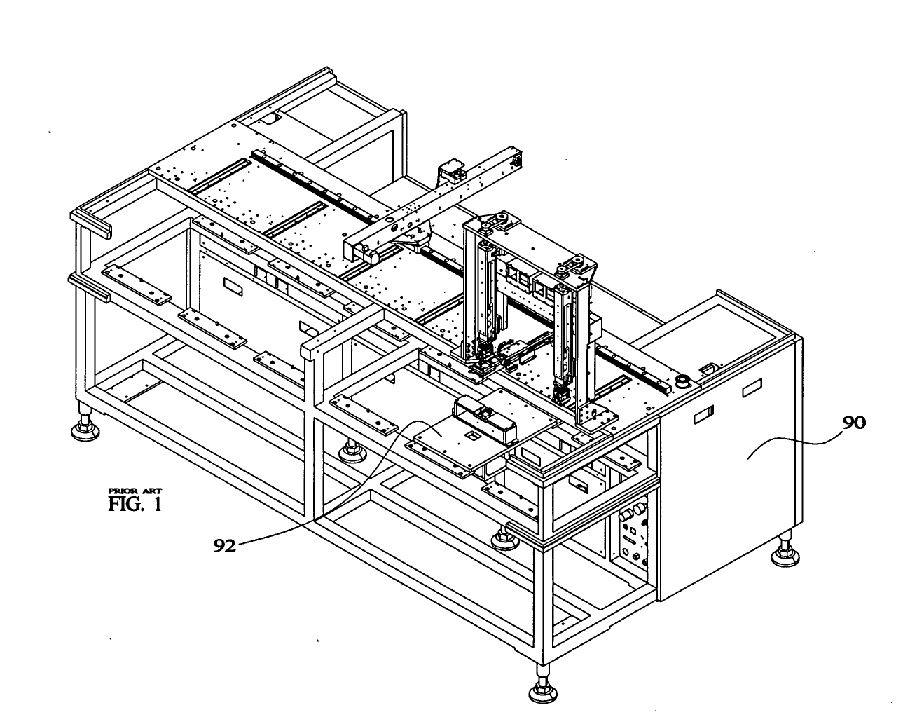

FIG. 2 is a schematic diagram of the testing apparatuses;

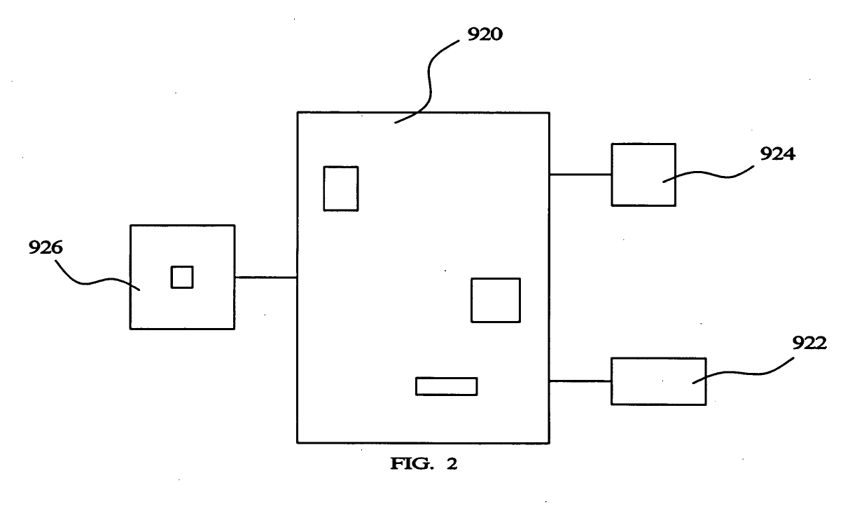

FIG. 3 is a structural block diagram showing the IC testing system according to the present invention; and

FIG. 4 is a flow chart explaining a preferred embodiment of the method for automatic dispatching IP addresses to each testing apparatus in a testing system according to the present invention.

### DETAILED DESCRIPTION OF THE PREFERRED EMBODIMENTS

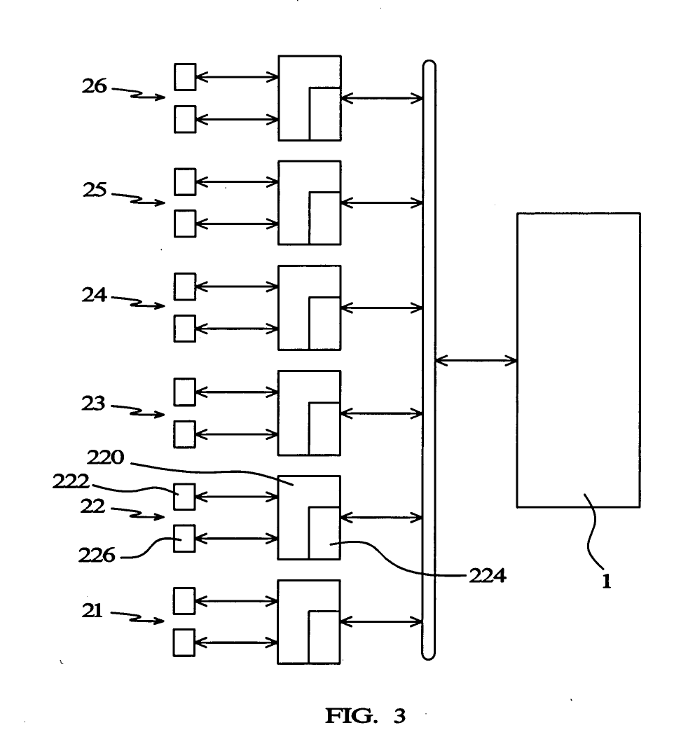

The testing system 1 of the preferred embodiment according to the present invention is shown in FIG. 3, which includes a control device 1, and six testing apparatuses 21, 22, 23, 24, 25 and 26. Although the testing system in this embodiment is exemplified by installation of six testing apparatuses, the present invention is not limited to this.

Since the structure of each testing apparatus is identical, here only the testing apparatus 22 represents an exemplification for simplicity. The apparatus 22 includes: a connector 226, a testing circuit board 220 for positioning an IC under test thereon, a hard drive 222, which stores the relative executive software and is connected to said testing circuit board to serve as a memory device, and a network interface device 224, which is built in the testing circuit board 220 and stores an internal code, are disposed. Not only is the control device 1 electrically connected to the apparatus 22, controls on/off of the testing circuit board 220, it also interchanges information with the apparatus 22 via the network interface device 224.

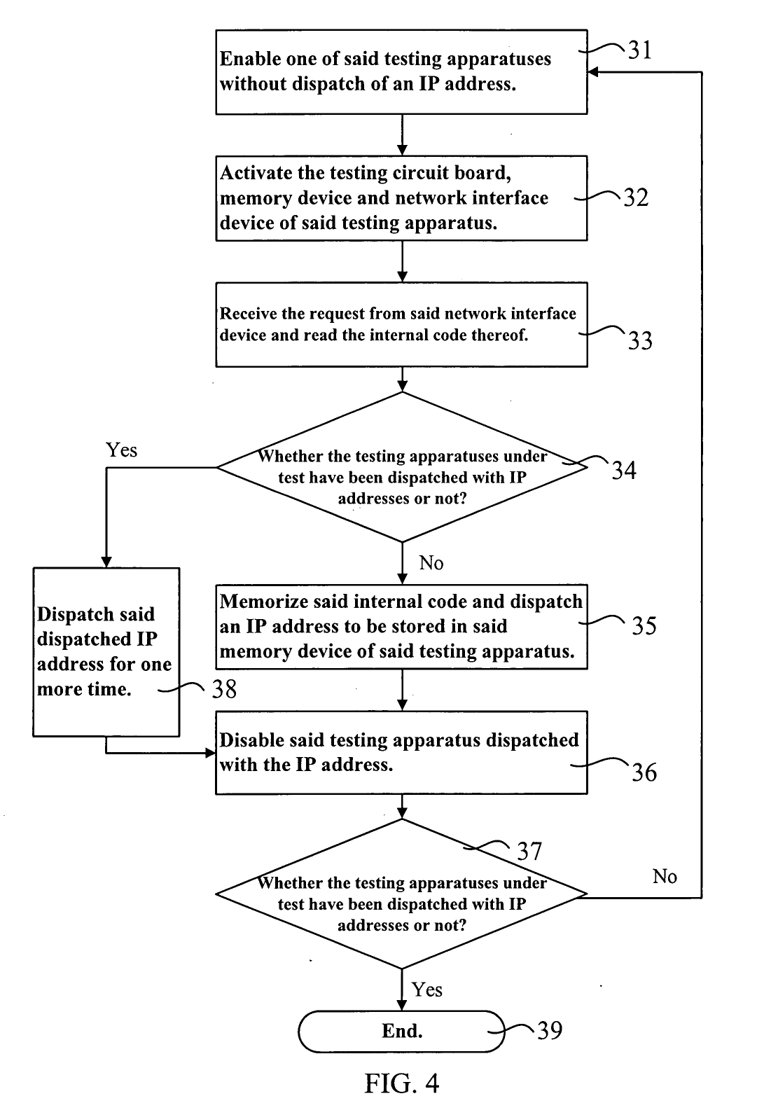

When the testing system turns on or the production conditions change, as shown in FIG. 4, in step 31, the control device 1 of the testing system first enables such as the testing apparatus 22 without dispatch of an IP address, at this time, the enabled testing apparatus 22 would activate the testing circuit board 220, memory device 222, and network interface device 224 in step 32. In step 33, the activated network interface device 224 would send the internal code thereof to the control device 1, and ask the control device 1 of the testing system for an IP address.

As the control device 1 of the testing system has received the request for an IP address, it would first recognize whether the network interface device 224 with this internal code has been dispatched with an IP address or not in step 34. If the internal code is one dispatched with an IP address, in step 38, the previously dispatched IP address is dispatched for one more time. If the internal code is one never dispatched with an IP address, the control device 1 of the testing system would memorize said internal code in step 35, and dispatch an IP address to be stored in said memory device 222 of said testing apparatus 22. After the dispatched IP address has been already stored in said memory device 222, then the control device 1 would disable the testing apparatus 22 dispatched with the IP address in step 36.

During step 37, the testing system inspects whether all the testing apparatuses under test have been already dispatched with IP addresses or not. If not, repeating step 31 to step 36, dispatch of IP addresses to the testing apparatuses never dispatched with an IP address is performed until all the testing apparatuses under test have been already dispatched with IP addresses, and then the procedure goes to step 39 and the action of dispatching IP addresses would be finished.

By following the method described above, the testing system could dispatch IP addresses to each testing apparatus 21, 22, 23, 24, 25 and 26 automatically. This automatic dispatching method could lower requirements and costs of human resource, so it would greatly reduce the chance of human error and the loss due to shutdown of the product lines, thus raising the accuracy and efficiency of the test, thus fulfilling the goals of this case.

What has been described above are the preferred embodiments of the present invention only, it is not intended to limit the scope of practice of the present invention, in principle, simple equivalent changes and modifications made according to the claims and specification should be included within the scope of the claims.

What is claimed is:

1. A method for automatic dispatching IP addresses to each testing apparatus in a testing system, allowing to recognize a plurality of testing apparatuses for sensing the electrical properties of a plurality of the homotypic circuit elements/devices under test in a predetermined circuit environment, wherein the each testing apparatus comprises a testing circuit board for positioning a circuit element/device under test thereon; a network interface device, which is installed on the testing circuit board and stores an internal code; and a memory device connected to the testing circuit board, respectively; said method comprises the steps of:
a) individually enabling one of said testing apparatuses, activating the testing circuit board, memory device and network interface device of said testing apparatus;
b) receiving the request from said network interface device, reading the internal code thereof;
c) memorizing said internal code, dispatching an IP address to be stored in said memory device of said testing apparatus; and
d) disabling said testing apparatus dispatched with the IP address, enabling another one of said testing apparatuses without dispatch of an IP address, wherein all the dispatched IP addresses are nonrepeatable, continuing the above-mentioned steps until said testing apparatuses are all dispatched with IP addresses and thereby said system could recognize said each testing apparatus clearly.

2. The method for automatic dispatching IP addresses to each testing apparatus in a testing system described in claim 1, wherein step d) further comprises a step of inspecting whether all the testing apparatuses under test have been dispatched with IP addresses or not by a control device in the system.

3. The method for automatic dispatching IP addresses to each testing apparatus in a testing system described in claim 1, between said steps b) and c), further comprising a step e) of evaluating and confirming whether said apparatus has been dispatched with an IP address or not, when said apparatus has been dispatched with an IP address, said dispatched IP address is dispatched for one more time.

4. A testing system, allowing to sense the electrical properties of a plurality of the homotypic circuit elements/devices under test in a predetermined circuit environment, the system comprises:
a plurality of testing apparatuses, the each testing apparatus comprising:
a testing circuit board for positioning a circuit element/device under test thereon;
a network interface device, which is installed on the testing circuit board and stores an internal code; and
a memory device connected to the testing circuit board, respectively; and
a control device, which connects, enables and manipulates the each testing apparatus, provides to receive the electrical properties of said circuit elements/devices under test, and automatically dispatches IP addresses to the each testing apparatus.
